(19) United States
(12) Patent Application Publication
(10) Pub. No.: US 2024/0097342 A1
(43) Pub. Date: Mar. 21, 2024

(54) ANTENNA, ANTENNA MODULE, AND ELECTRONIC DEVICE

(71) Applicant: KYOCERA Corporation, Kyoto-shi, Kyoto (JP)

(72) Inventors: Tatsuya MORITA, Soraku-gun (JP); Daisuke YAMAMOTO, Kizugawa-shi (JP); Kazuki HAYATA, Soraku-gun (JP); Takaki NAKAJIMA, Soraku-gun (JP)

(73) Assignee: KYOCERA Corporation, Kyoto-shi, Kyoto (JP)

(21) Appl. No.: 18/277,345

(22) PCT Filed: Feb. 18, 2022
(86) PCT No.: PCT/JP2022/006580

§ 371 Date: Aug. 15, 2023

(30) Foreign Application Priority Data
Feb. 24, 2021 (JP) 2021-027055

(51) Int. Cl. H01Q 13/08; H01Q 21/24

(52) U.S. Cl. CPC H01Q 13/08; H01Q 21/24

(57) ABSTRACT

An antenna includes a conductive patch. The patch includes, in a plan view, a first power feed-side edge and a first non-power feed-side edge positioned on opposite sides in a first direction in one-to-one relation, and a second power feed-side edge and a second non-power feed-side edge positioned on opposite sides in a second direction intersecting the first direction in one-to-one relation. The patch includes, in the plan view, a first power feed point positioned on a side nearer to the first power feed-side edge and a second power feed point positioned on a side nearer to the second power feed-side edge. In the plan view, at least a portion of the first power feed-side edge expands outward and forms a protrusion. A width of the protrusion in the second direction gradually decreases toward a top of the protrusion. The first power feed point is positioned nearer to the top of the protrusion than a middle of a hill slope of the protrusion in the first direction.

### TECHNICAL FIELD

The present disclosure relates to an antenna, an antenna module including the antenna, and an electronic device including the antenna module.

### BACKGROUND OF INVENTION

A known example of a patch antenna can transmit and/or receive two linearly polarized waves with vibration directions orthogonal to each other (for example, FIG. 11 of PATENT LITERATURE 1 given below). Such a patch antenna has, for example, a square shape in a plan view.

### CITATION LIST

### Patent Literature

Patent Literature 1: Japanese Unexamined Patent Application Publication No. 2019-102885.

### SUMMARY

According to an aspect of the present disclosure, an antenna includes a conductive power feed patch. The power feed patch includes, in a plan view, a first power feed-side edge, a first non-power feed-side edge, a second power feed-side edge, a second non-power feed-side edge, a first power feed point, and a second power feed point. The first power feed-side edge and the first non-power feed-side edge are positioned, in the plan view, on opposite sides in a first direction in one-to-one relation. The second power feed-side edge and the second non-power feed-side edge are positioned, in the plan view, on opposite sides in a second direction intersecting the first direction in one-to-one relation. The first power feed point is positioned, in the plan view, on a side nearer to the first power feed-side edge. The second power feed point is positioned, in the plan view, on a side nearer to the second power feed-side edge. In the plan view, at least a portion of the first power feed-side edge expands outward and forms a protrusion. A width of the protrusion in the second direction gradually decreases toward a top of the protrusion. The first power feed point is positioned nearer to the top of the protrusion than a middle of a hill slope of the protrusion in the first direction.

According to another aspect of the present disclosure, an antenna includes a conductive power feed patch. The power feed patch includes, in a plan view, a first power feed-side edge, a first non-power feed-side edge, a second power feed-side edge, a second non-power feed-side edge, a first power feed point, and a second power feed point. The first power feed-side edge and the first non-power feed-side edge are positioned, in the plan view, on opposite sides in a first direction in one-to-one relation. The second power feed-side edge and the second non-power feed-side edge are positioned, in the plan view, on opposite sides in a second direction intersecting the first direction in one-to-one relation. The first power feed point is positioned, in the plan view, on a side nearer to the first power feed-side edge. The second power feed point is positioned, in the plan view, on a side nearer to the second power feed-side edge. The power feed patch further includes a non-power feed-side slit extending in parallel to the second non-power feed-side edge at a position on a side nearer to the second non-power feed-side edge.

According to still another aspect of the present disclosure, an antenna module includes the antenna described above and an IC (Integrated Circuit) electrically connected to the first power feed point and the second power feed point.

According to still another aspect of the present disclosure, an electronic device includes the antenna module described above and a housing accommodating the antenna module.

### BRIEF DESCRIPTION OF THE DRAWINGS

FIG. 1 is a perspective view of an antenna according to a first embodiment.

FIG. 2 is a plan view of a first conductor layer in the antenna of FIG. 1.

FIG. 3 is a plan view of a second conductor layer in the antenna of FIG. 1.

FIG. 4 is a plan view of a first conductor layer in an antenna according to a second embodiment.

FIG. 5 is a plan view of a first conductor layer in an antenna according to a variation.

FIG. 6 is a plan view of a first conductor layer in an antenna according to a third embodiment.

FIG. 7 is a plan view of a first conductor layer in an antenna according to a fourth embodiment.

FIG. 8 is a perspective view of an antenna according to a fifth embodiment.

FIG. 9 is a plan view of the antenna of FIG. 8 when viewed in a seeing-through way.

FIG. 10 is a schematic view illustrating a configuration of an electronic device according to an embodiment.

FIG. 11A is a graph representing characteristics of an antenna according to COMPARATIVE EXAMPLE.

FIG. 11B is a graph representing characteristics of an antenna according to EXAMPLE.

FIG. 12 is a graph representing characteristics of antennas according to COMPARATIVE EXAMPLE and EXAMPLES.

### DESCRIPTION OF EMBODIMENTS

Embodiments of the present disclosure will be described below with reference to the drawings. The drawings referenced in the following description are merely illustrative, and dimension ratios, for example, on the drawings are not always in agreement with actual ones. The illustration and/or the description of insignificant details is omitted in some cases. Thus, even when a shape is expressed as being rectangular, for example, corners may be chamfered to such an extent as not significantly affecting characteristics of an antenna and so on.

For convenience, an orthogonal coordinate system x, y, and z fixedly defined on the antenna is illustrated on the drawing, and the description is made with reference to the illustrated orthogonal coordinate system in some cases. While the antenna may be disposed with any desired direction set to be upward or downward, a word, such as an upper surface or a lower surface, is used in some cases for convenience on an assumption that a positive side in a z-direction is an upper side. The term “in a plan view” indicates the case of viewing an object in the z-direction unless otherwise specified.

In the drawings, for better viewability of a planar pattern of a conductor layer, hatching may be applied to a surface of the conductor layer (namely, a surface not being a cross-section of a member) in some cases. It is to be understood that a “layer”, indicated by the word “conductor layer” or the like, may include a “plate”.

In the description of any of embodiments other than a first embodiment, different points from one or more embodiments mentioned earlier than the embodiment of interest are explained basically. The matters that are not specifically referred to may be understood as being the same as and/or similar to those in the one or more embodiments mentioned earlier or may be estimated from the one or more embodiments mentioned earlier.

The antenna can be utilized in transmission and/or reception. However, the description is made with regard to transmission alone in some cases for convenience. Regardless of whether the antenna is utilized in transmission, a term suggesting the transmission, such as a “power feed point”, is used in some cases according to practices. A wavelength used in the description of the embodiments is, unless otherwise specified, the wavelength of an electric wave with a frequency targeted by the antenna (for example, a center frequency of a predetermined band).

Analogous components are denoted in some cases by adding, to the same names, different ordinal numbers (“first” and “second”) and suffixes given by different capital alphabets (“A” and “B”), for example, such as a “first power feed via 9A” and a “second power feed via 9B”. In that case, a simpler expression “power feed via 9” is also used without distinguishing both the analogous components from each other.

### First Embodiment

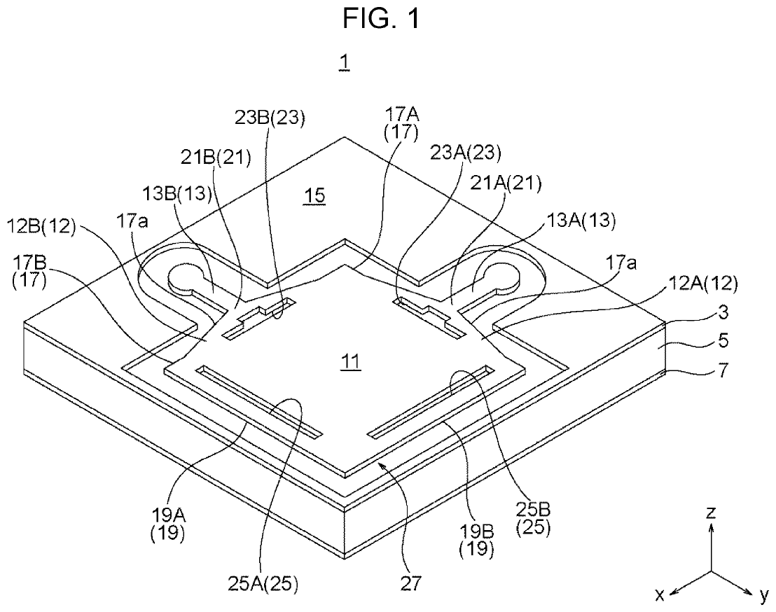

FIG. 1 is a perspective view illustrating a configuration of an antenna 1 according to a first embodiment.

The antenna 1 can transmit and/or receive two linearly polarized waves with vibration directions intersecting (for example, orthogonal to) each other. In one of the two linearly polarized waves, the vibration direction of an electric field is an x-direction. In the other of the two linearly polarized waves, the vibration direction of an electric field is a y-direction. A direction in which the antenna 1 exhibits a maximum gain is a +z-direction. A frequency band in which the antenna 1 is utilized is set as desired.

The antenna 1 capable of transmitting and/or receiving the two linearly polarized waves as described above can be utilized as an antenna that is adaptable for transmission and/or reception of both a vertically polarized wave and a horizontally polarized wave. In another example, the antenna 1 can also be used to transmit and/or receive a circularly polarized wave. In the following description, a state of transmitting and/or receiving one of the two linearly polarized waves is assumed, and the one polarized wave to be transmitted and/or received is referred to as a “main polarization” in some cases.

The antenna 1 has the shape of a flat plate with a substantially constant thickness. Although not illustrated specifically, an upper surface and/or a lower surface of the antenna 1 may be covered with another member (for example, a dielectric layer). From a different point of view, the illustrated shape of the flat plate may be the shape of a portion of a member (for example, a substrate with a thickness direction set to the z-direction) including the antenna 1.

The plan shape of the antenna 1 illustrated in FIG. 1 represents a shape obtained, for example, when the portion of the flat plate (substrate) including the antenna 1 is cut out as appropriate for the purpose of illustration. Stated another way, an illustrated side surface of the antenna 1 is a cross-section of the above-mentioned substrate and does not represent a contour of the antenna 1 in some cases. However, the side surface illustrated in FIG. 1 may be an actual side surface of the antenna 1. Furthermore, regardless of whether the antenna 1 is the portion of the substrate, the illustrated side surface of the antenna 1 may be regarded as representing the contour of the antenna 1. In a configuration in which the plan shape of the antenna 1 can be specified, that plan shape may be any desired shape. The plan shape of the antenna 1 may be, for example, rectangular (illustrated example), any of other polygonal shapes, circular, or elliptic.

A size of the antenna 1 may be set as appropriate depending on, for example, a frequency band in which the antenna 1 is utilized. The following description is made in some cases with regard to, for example, a configuration in which the antenna 1 is utilized in a relatively high frequency band and has a relatively small size. For example, the antenna 1 may be utilized in a frequency band of 300 MHz or higher or 3 GHz or higher and in a frequency band of 30 GHz or lower or 300 GHz or lower. The above-mentioned upper and lower limits may be combined as appropriate. Lengths of an illustrated region (or a patch 11 described later) in the x-direction and the y-direction may be, for example, 1 mm or longer and 100 mm or shorter. A thickness of the antenna 1 may be, for example, 0.1 mm or more and 10 mm or less. The antenna 1 of such a relatively small size may be constituted as, for example, an electronic component to be assembled into an electronic device. However, the antenna 1 may have a size of several ten centimeters or larger or several meters or larger in a plan view.

The antenna 1 has, for example, a line-symmetric configuration with respect to a symmetry axis (not illustrated) extending from a +x- and +y-side toward −x- and −y-side at an inclination angle of 45° relative to an x-axis and a y-axis in the plan view. In the description of the embodiments, line-symmetrical ones among constituent element of the antenna 1 are explained without distinguishing those constituent element from each other or explained about just one of them for convenience.

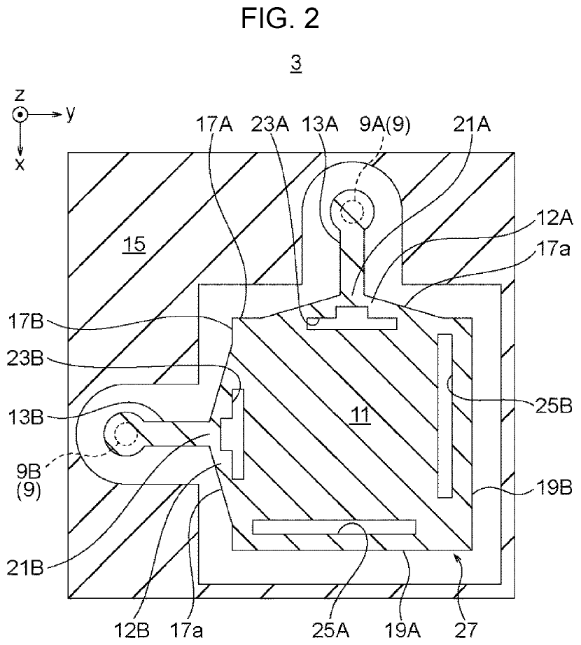

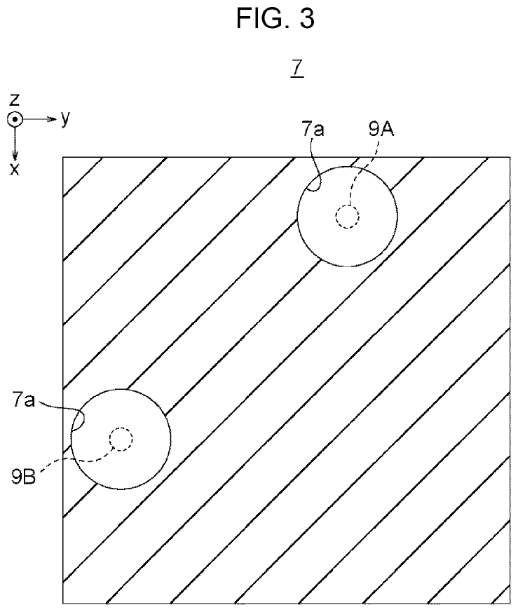

The antenna 1 includes, for example, a first conductor layer 3, a dielectric layer 5, and a second conductor layer 7 that are laminated in order from the +z-side. The antenna 1 further includes, for example, a power feed via 9 (a first power feed via 9A and a second power feed via 9B, see FIGS. 2 and 3) penetrating the dielectric layer 5. The first conductor layer 3 includes the patch 11 and directly contributes to transmission and/or reception of an electric wave. The second conductor layer 7A is a layer to which reference potential is applied, and it serves as the so-called ground plate. The dielectric layer 5 contributes to, for example, supporting the first conductor layer 3 and the second conductor layer 7 and keeping insulation between both the layers. The power feed via 9 contributes to feeding power to the patch 11.

In the antenna 1, configurations other than the plan shape of the first conductor layer 3 may be the same as and/or similar to those of a known patch antenna (of course, may be novel configurations). In the following, description of the configurations that may be the same as and/or similar to the known ones is omitted as appropriate in some cases.

(Conductors)

A thickness of each conductor layer (the first conductor layer 3, the second conductor layer 7, or any of other conductor layers in the embodiments described later) and a shape and a size of each shaft-shaped conductor (the power feed via 9) intersecting the conductor layer may be set as appropriate in consideration of characteristics of the antenna 1 and so on. The thickness of the conductor layer may be smaller than that of the dielectric layer. In an example, the thickness of the conductor layer is 1 μm or more and 1 mm or less.

Materials of various conductor members (the first conductor layer 3, the second conductor layer 7, the power feed via 9, and the other conductor members in the embodiments described later) are, for example, metals. The metals may be selected as appropriate from Cu, Al, and so on. The materials of the various conductor members may be the same or different from one another. Furthermore, each conductor member may be made of a single material or multiple materials. An example of the latter case is a conductor layer in which layers made of different materials are laminated.

In a connected portion between the conductor layer (for example, the first conductor layer 3) and the shaft-shaped conductor (for example, the power feed via 9) orthogonal to the conductor layer, an upper surface or a lower surface of the conductor layer and an end surface of the shaft-shaped conductor may be joined to each other, or the shaft-shaped conductor may penetrate the conductor layer, or a state of the connection therebetween may be difficult to recognize in a distinguishable way from the viewpoint of material and so on. For convenience, the following description is made in some cases with regard to, for example, a configuration in which the shaft-shaped conductor is joined to the upper surface or the lower surface of the conductor layer.

(Dielectric Layer)

The description (stated above) regarding the plan shape of the antenna 1 and the size thereof in the plan view may be further applied to a plan shape of the dielectric layer 5 and a size thereof in the plan view. A thickness of the dielectric layer 5 may be set as appropriate such that the characteristics of the antenna are improved. A method of setting the thickness may be, for example, the same as and/or similar to a setting method for the known patch antenna.

The dielectric layer 5 may be made of a single material or multiple materials. When the dielectric layer 5 is made of multiple materials, the dielectric layer 5 may be formed, for example, by laminating dielectric layers made of different materials in a thickness direction and/or by impregnating a base material made of a glass cloth with a dielectric. The material (dielectric) of the dielectric layer 5 is, for example, ceramic and/or resin.

(First Conductor Layer)

FIG. 2 is a plan view of the first conductor layer 3.

As illustrated in FIGS. 1 and 2, the first conductor layer 3 includes the patch 11 directly contributing to the transmission and the reception of the electric wave, a power feed line 13 (a first power feed line 13A and a second power feed line 13B) for feeding power to the patch 11, and a ground pattern 15 surrounding the patch 11. The first power feed line 13A contributes to feeding power for transmission and/or reception of an electric wave vibrating in the x-direction. The second power feed line 13B contributes to feeding power for transmission and/or reception of an electric wave vibrating in the y-direction. The ground pattern 15 contributes to cutting off, for example, an electric wave parallel to an xy-plane.

(Patch)

The patch 11 has a plan shape modified from, for example, a square as a base. The patch 11 includes four edges corresponding to four sides of the square. In more detail, the patch 11 includes a first power feed-side edge 17A and a first non-power feed-side edge 19A positioned on opposite sides in the x-direction in one-to-one relation, and a second power feed-side edge 17B and a second non-power feed-side edge 19B positioned on opposite sides in the y-direction in one-to-one relation.

The plan shape of the patch 11 is different from that of a known patch mainly in, for example, three points given below. The power feed-side edge 17 expands outward and forms a protrusion 12 (a first protrusion 12A and a second protrusion 12B). A power feed-side slit 23 (a first power feed-side slit 23A and a second power feed-side slit 23B) extending in parallel to the power feed-side edge 17 in the plan view is formed. A non-power feed-side slit 25 (a first non-power feed-side slit 25A and a second non-power feed-side slit 25B) extending in parallel to the non-power feed-side edge 19 in the plan view is formed.

The above-described features each contribute to, for example, when one (main polarization) of the two linearly polarized waves vibrating in the x-direction or the y-direction is transmitted and/or received, causing the direction of a current induced from the main polarization to orient in the vibration direction of the main polarization. As a result, for example, when the main polarization is transmitted and/or received, the influence of the other (the polarized wave not intended, cross polarization) of the two polarized waves upon the transmission and/or the reception of the main polarization is reduced.

In the following description of the patch 11, other configurations than the above-mentioned three features are first explained. After that, the above-mentioned three features are explained.

The patch 11 may be formed as, for example, a half-wavelength patch. Here, the half-wavelength patch is assumed to be a patch in which a length of the patch 11 in each of the x-direction and the y-direction is set on the basis of ½×λg. Here, kg indicates an effective wavelength at the position of the patch 11 in consideration of the dielectric constant of the dielectric layer 5 and so on. The wording “on the basis of ½×λg” indicates that, while the length of ½×λg is used in theory in a simple way, a length adjusted from ½×λg may be used in practical use. The patch 11 may be applied to the so-called inverted F antenna and may be constituted as a ¼-wavelength patch with a length set on the basis of ¼×λg.

The power feed-side edge 17 is connected to the power feed line 13. The non-power feed-side edge 19 corresponds to an opposite side to the power feed-side edge 17. In the following description of the embodiments, when the length of the power feed-side edge 17 and so on are referred to, it is assumed that the power feed-side edge 17 imaginarily exists in a portion connected to the power feed line 13.

The connected portion between the power feed-side edge 17 and the power feed line 13 serves as a power feed point 21 (a first power feed point 21A and a second power feed point 21B). While the word “point” is used according to practices, it is apparent from the example illustrated in the drawing as well that the power feed point may have a shape other than a point. The power feed point 21 may be regarded as a portion of the patch 11. The patch 11 is not required to have a different configuration at the position of the power feed point 21 from that of another region in the patch 11, and the power feed point 21 may be specified from a relationship to another member (the power feed line 13 in the illustrated example).

In the description of this embodiment, description regarding a relationship between the power feed-side edge 17 and the power feed point 21 (or the power feed line 13) may be regarded, unless otherwise specified, as description regarding a relationship between the first power feed-side edge 17A and the first power feed point 21A (or the first power feed line 13A) and description regarding a relationship between the second power feed-side edge 17B and the second power feed point 21B (or the second power feed line 13B).

In the illustrated example, the power feed point 21 is formed by the connection of the power feed line 13 to the power feed-side edge 17 and hence positioned at the power feed-side edge 17. From a different point of view, it can also be said that the power feed point 21 is positioned on a side nearer to the power feed-side edge 17 within the patch 11. When the position of the power feed point 21 is expressed as mentioned above, the power feed point 21 is not required to be positioned at the power feed-side edge 17 unlike the illustrated example. For example, although not illustrated specifically, the power feed point 21 may be formed by directly connecting the power feed via 9 to the patch 11 without disposing the power feed line 13. In that case, the power feed point 21 may be positioned inside the patch 11 away from the power feed-side edge 17. The description of this embodiment is, however, made in some cases for convenience on the premise that the power feed point 21 is positioned at the power feed-side edge 17 as illustrated.

When the expression that the power feed point 21 is positioned on a “side nearer to the power feed-side edge 17” within the patch 11 is used as mentioned above, the “side nearer to the power feed-side edge 17” may be, for example, a side nearer to the power feed-side edge 17 than the geometrical center of the patch 11. Alternatively, when a region between the power feed-side edge 17 and the non-power feed-side edge 19 opposing to each other is divided into three or five equal parts, the “side nearer to the power feed-side edge 17” may be a position within the region nearest to the power feed-side edge 17. Regarding the above-mentioned geometrical center and equal divisions, expansion (described later) of the power feed-side edge 17 in later description may be ignored (or taken into consideration). While the position of the power feed point 21 relative to the power feed-side edge 17 is described above, the above description is further likewise applied to a position of another constituent element (for example, the slit described later) and positions of other constituent elements relative to the non-power feed-side edge 19. When it is determined whether the power feed point 21 (or another constituent element) is positioned on the side nearer to the power feed-side edge 17 (or another edge), the geometrical center or the whole of the plan shape of the power feed point 21 (or another constituent element) may be taken into consideration for reference.

The power feed point 21 is positioned, for example, at the center of the power feed-side edge 17 in a length direction thereof. The patch 11 does not have a line-symmetric shape with respect to an imaginary line (center line parallel to the x-direction or the y-direction) that is orthogonal to the power feed-side edge 17 and that passes a center position of the power feed-side edge 17. Accordingly, in consideration of the above point, the power feed point 21 may be disposed at a position adjusted from the (accurate) center position of the power feed-side edge 17 with intent to improve the characteristics of the antenna 1. In the description of the present disclosure, the wording “the center of the power feed-side edge 17 (the non-power feed-side edge 19)” may include a position after being adjusted as described above.

(Protrusion of Patch)

The following description regarding a relationship among the protrusion 12, the power feed-side edge 17, and the power feed point 21 may be regarded, unless otherwise specified, as description regarding a relationship among the first protrusion 12A, the first power feed-side edge 17A, and the first power feed point 21A and description regarding a relationship among the second protrusion 12B, the second power feed-side edge 17B, and the second power feed point 21B.

As described above, at least a portion of the power feed-side edge 17 expands toward the outside of the patch 11, and the patch 11 includes the protrusion 12. In other words, assuming an imaginary straight line (namely, a bottom side of the protrusion 12) connecting opposite ends of the power feed-side edge 17 (intersection positions between the power feed-side edge 17 and the other edges), at least a portion of the power feed-side edge 17 is positioned on an outer side of the patch 11 than the above-mentioned imaginary straight line.

In the protrusion 12, its width (for example, a y-directional length of the protrusion 12 protruding toward the −x-side) gradually decreases (in a tapered shape) toward a top of the protrusion 12. In other words, the power feed-side edge 17 has a slope 17a. The slope 17a is inclined with respect to the imaginary straight line connecting the opposite ends of the power feed-side edge 17 such that the slope 17a is positioned on an even outer side of the patch 11 (for example, toward the −x-side in the case of the slope 17a of the first power feed-side edge 17A) as a position on the slope 17a comes nearer to the center of the power feed-side edge 17 from the end of the power feed-side edge 17 including the slope 17a.

The power feed point 21 is positioned at the top of the protrusion 12. Comparing with a configuration in which the patch 11 has a square shape, therefore, the patch 11 gradually spreads toward the center of the patch 11 from the power feed point 21. As a result, for example, a current supplied to the patch 11 from the power feed point 21 is less likely to go toward opposite sides of a direction orthogonal to a direction toward the center of the patch 11 from the power feed point 21 (for example, toward opposite sides in the y-direction in the case of the first power feed point 21A) than the current in the configuration in which the patch 11 has the square shape. Thus, it becomes easier to orient the direction of the current induced from the main polarization in the vibration direction of the main polarization.

A size of the protrusion 12 in the length direction of the power feed-side edge 17 may be set as appropriate. For example, the protrusion 12 may be positioned in a part of the power feed-side edge 17 (illustrated example) or over the whole of the power feed-side edge 17. In the former case, a proportion of the protrusion 12 to a length of the imaginary straight line connecting the opposite ends of the power feed-side edge 17 may be set as appropriate and may be set to be, for example, less than ⅓, ⅓ or more and less than ½, ½ or more and ⅘ or less, or more than ⅘.

In the configuration in which the protrusion 12 occupies a part of the length of the power feed-side edge 17, the protrusion 12 is positioned, for example, at the center of the power feed-side edge 17. In more detail, for example, the geometrical center or the top of the protrusion 12 may be positioned at the center of the power feed-side edge 17 in the length direction (the x-direction or the y-direction) of the power feed-side edge 17. The word “center” used here may include a position after being adjusted from the accurate center in consideration of asymmetry with respect to the center line parallel to the x-direction or the y-direction as described above in connection with the position of the power feed point 21.

In the protrusion 12, an amount by which the protrusion 12 protrudes from the imaginary straight line connecting the opposite ends of the power feed-side edge 17 may be set as appropriate. The amount of the protrusion may be set to, for example, 1/20 or more and ⅕ or less of the length of the above-mentioned imaginary straight line. From a different point of view, an angle of the slope 17a relative to the imaginary straight line connecting the opposite ends of the power feed-side edge 17 including the slope 17a may be set as appropriate. That angle may be set to, for example, 5° or more, 10° or more, or 30° or more and 60° or less, 45° or less, or 30° or less. The above-mentioned upper and lower limits may be combined as appropriate insofar as there occur no contradictions.

A specific shape of the protrusion 12 is set as desired. For example, the protrusion 12 may have a line-symmetric shape (illustrated example) or an asymmetric shape with respect to a symmetry axis that is orthogonal to the imaginary straight line connecting the opposite ends of the power feed-side edge 17 and that passes the power feed point 21. In the latter case, for example, the influence of asymmetry of the overall shape of the patch 11 with respect to the center line parallel to the x-direction or the y-direction upon the characteristics of the antenna 1 may be taken into consideration. Furthermore, the slope 17a may have, for example, a straight shape (illustrated example), a curved shape expanding outward, a curved shape recessed inward, or a stepped shape. From a different point of view, the protrusion 12 may have a polygonal shape such as a triangular or trapezoidal shape, a semicircular shape, or a semi-elliptical shape.

A positional relationship between the protrusion 12 and the power feed point 21 may be set as appropriate. In the illustrated example, since the power feed point 21 is formed by the power feed line 13 being connected to the power feed-side edge 17, the power feed point 21 is positioned at the power feed-side edge 17 and at the top (apex) of the protrusion 12. However, as described above, the power feed point 21 may be formed, for example, by the power feed via 9 being directly connected to the patch 11 and, in this case, the power feed point 21 may be positioned away from the power feed-side edge 17. Moreover, the power feed point 21 may be positioned away from the top of the protrusion 12. Even in the configuration in which the power feed point 21 is positioned at the power feed-side edge 17, a slight deviation may exist between the power feed point 21 and the top of the protrusion 12.

In consideration of the above-described different configurations as well, the power feed point 21 may be positioned, for example, nearer to the top of the protrusion 12 than a middle of a hill slope of the protrusion 12. The middle of the hill slope indicates a midpoint between the imaginary straight line connecting the opposite ends of the power feed-side edge 17 and the top of the protrusion 12 in a height direction (the x-direction or the y-direction) of the protrusion 12. Thus, stated another way, the position of the power feed point 21 may be set to a position at which a distance from the protrusion 12 is less than ½ of the protrusion amount in the height direction of the protrusion 12. Alternatively, a limitation in the above distance may be set to be less than ⅓, less than ⅔, or less than another threshold instead of ½. When the power feed point 21 has a length in the height direction of the protrusion 12 as in the configuration in which the power feed point 21 is formed by the power feed via 9, the geometrical center or the whole of the power feed point 21 in the plan view may be taken into consideration for reference in the above-described determination as to the position of the power feed point 21.

Unlike the first power feed-side edge 17A, the first non-power feed-side edge 19A has, for example, a straight shape like a side of a square. From a different point of view, the first non-power feed-side edge 19A is more closely analogous to a straight line than the first power feed-side edge 17A. When the expression “one edge is more closely analogous to a straight line than the other edge” is used as mentioned above, the one edge may be or may not be a straight line. The above description is made about the first non-power feed-side edge 19A and the first power feed-side edge 17A, but it is further applied to the second non-power feed-side edge 19B and the second power feed-side edge 17B as well.

Which one of the two edges is more closely analogous to a straight line may be determined as appropriate. In an example, an index value may be given as a value resulting from dividing a maximum deviation amount of each edge relative to an imaginary straight line connecting opposite ends of that edge by a length of the imaginary straight line. Two index values calculated for the two edges may be compared with each other, and the edge with the relatively small index value may be determined to be more closely analogous to a straight line.

(Power Feed-Side Slit in Patch)

The following description regarding a relationship among the power feed-side slit 23, the protrusion 12, the power feed-side edge 17, and the power feed point 21 may be regarded, unless otherwise specified, as description regarding a relationship among the first power feed-side slit 23A, the first protrusion 12A, the first power feed-side edge 17A, and the first power feed point 21A and description regarding a relationship among the second power feed-side slit 23B, the second protrusion 12B, the second power feed-side edge 17B, and the second power feed point 21B.

The power feed-side slit 23 extends in parallel to the power feed-side edge 17 at a position inside the patch 11 on a side nearer to the power feed-side edge 17. The meaning of the expression “on a side nearer to the power feed-side edge 17” is as per described above in connection with the power feed point 21. A current flowing in the patch 11 tends to flow along the power feed-side slit 23. Accordingly, for example, when the polarized wave in association with the second power feed point 21B (the polarized wave vibrating in the y-direction) is the main polarization (the intended polarized wave), the direction of the current induced from the main polarization is easier to orient in the vibration direction of the main polarization with the presence of the first power feed-side slit 23A. Likewise, when the polarized wave in association with the first power feed point 21A is the main polarization, the direction of the current induced from the main polarization is easier to orient in the vibration direction of the main polarization with the presence of the second power feed-side slit 23B.

As is apparent from the fact that the power feed-side edge 17 is not straight, when the expression “the power feed-side slit 23 extends in parallel to the power feed-side edge 17” is used, the power feed-side slit 23 and the power feed-side edge 17 are not required to be exactly parallel to each other. Furthermore, the power feed-side slit 23 may be formed in such a configuration that it can be regarded as being parallel or inclined with respect to the imaginary straight line connecting the opposite ends of the power feed-side edge 17.

For example, when a maximum length of the power feed-side slit 23 in a direction parallel to the imaginary straight line connecting the opposite ends of the power feed-side edge 17 (from a different point of view, parallel to the x-direction or the y-direction) is longer than a maximum length thereof in a direction orthogonal to the imaginary straight line (namely, a maximum width), the power feed-side slit 23 can be regarded as extending in parallel to the power feed-side edge 17. A ratio between the former maximum length to the latter maximum length may be set as appropriate, and the former maximum length may be set to, for example, 1.5 times or more, 2 times or more, 3 times or more, or 4 times or more the latter maximum length.

The power feed-side slit 23 may have any of various shapes. For example, the power feed-side slit 23 may extend in a constant width or may include portions with different widths (illustrated example). In another example, the power feed-side slit 23 may extend linearly or may include a bent or curved portion. In still another example, the power feed-side slit 23 may have a line-symmetric or asymmetric shape with respect to a symmetry axis along a length direction of the power feed-side slit 23 and/or a symmetry axis along a width direction thereof.

In the illustrated example, an edge of the power feed-side slit 23 on the same side as the center of the patch 11 is a straight line. This straight line is, for example, parallel to the imaginary straight line connecting the opposite ends of the power feed-side edge 17 (from a different point of view, parallel to the x-direction or the y-direction). On the other hand, an edge of the power feed-side slit 23 on the same side as the power feed point 21 protrudes toward the power feed point 21. Stated another way, the slit edge on the same side as the power feed point 21 is positioned on a side nearer to the power feed point 21 in a direction intersecting the imaginary straight line (for example, the x-direction in the case of the first power feed-side slit 23A) at a location nearer to the power feed point 21 in a direction along the imaginary straight line (for example, the y-direction in the case of the first power feed-side slit 23A). Stated still another way, a width of the power feed-side slit 23 (for example, a length of the first power feed-side slit 23A in the x-direction) increases toward the power feed point 21.

The specific protruding shape of the power feed-side slit 23 toward the power feed point 21 may be set as appropriate. For example, the edge of the power feed-side slit 23 on the same side as the power feed point 21 may be formed in a stepped shape (illustrated example) or a straight or smoothly curved shape. In the stepped edge, the number of steps may be one (illustrated example) or two or more. A tread surface of the step may be parallel (illustrated example) or inclined with respect to the edge of the power feed-side slit 23 on an opposite side to the power feed point 21. A surface rising to the tread surface of the step may be orthogonal (illustrated example) or inclined with respect to the edge of the power feed-side slit 23 on the opposite side to the power feed point 21.

A protrusion amount of the protruding shape of the power feed-side slit 23 (a size of one step in the illustrated example) and a width of the protruding shape (a length thereof in a direction orthogonal to a protruding direction) may be set to appropriate values. In the illustrated example, the protrusion amount and the width of the protruding shape defined by the edge of the power feed-side slit 23 on the same side as the power feed point 21 are set such that the stepped shape is approximated by a straight line parallel to the slope 17a of the power feed-side edge 17.

A length of the power feed-side slit 23 may be set as appropriate. The length of the power feed-side slit 23 may be set to, for example, ⅕ or more and ⅘ or less of that of the power feed-side edge 17 or may be set to a value outside the above-mentioned range. Furthermore, the length of the power feed-side slit 23 may be set to, for example, ⅓ or more and ⅔ or less of the width of the protrusion 12 (for example, the length in the y-direction in the case of the first protrusion 12A) or may be set to a value outside the above-mentioned range.

A width of the power feed-side slit 23 may be set as appropriate. A minimum width of the power feed-side slit 23 may be set to be, for example, equal to or greater than a minimum value at which dielectric breakdown does not occur when a voltage at a level expected for the patch 11 is applied. The minimum width of the power feed-side slit 23 may also be set to, for example, 1/20 or more and ⅕ or less of the length of the power feed-side slit 23 or may be set to a value outside the above-mentioned range. A maximum width of the power feed-side slit 23 may be set to, for example, 1/10 or more and ⅓ or less of the length of the power feed-side slit 23 or may be set to a value outside the above-mentioned range.

A position of the power feed-side slit 23 may be set as appropriate in the length direction of the power feed-side edge 17. For example, the center of the overall length of the power feed-side slit 23 may be positioned at the center of the overall length of the power feed-side edge 17 (illustrated example) or may be deviated from a position of the latter center. From a different point of view, in the illustrated example, the center of the overall length of the power feed-side edge 17 is the position of the power feed point 21 in the length direction of the power feed-side edge 17 as described above.

The position of the power feed-side slit 23 may be set as appropriate in the direction orthogonal to the length direction of the power feed-side edge 17. For example, the power feed-side slit 23 may be formed to, relative to the imaginary straight line connecting the opposite ends of the power feed-side edge 17, entirely position inside the patch 11, overlap the imaginary straight line (illustrated example), or entirely position outside the patch 11. In the illustrated example, the edge of the power feed-side slit 23 in a minimum-width portion of the power feed-side slit 23 on the same side as the power feed-side edge 17 and the imaginary straight line substantially overlap each other.

A width (or a cross-sectional area) of a portion extending from the power feed point 21 toward the inner side of the patch 11 while passing through the surrounding of the power feed-side slit 23 (namely, a portion through which the current flows) may be taken into consideration in setting of the length, the width, and the position of the power feed-side slit 23. For example, the sum of a minimum width of a path extending around one side of the power feed-side slit 23 in the length direction and a minimum width of a path extending around the other side of the power feed-side slit 23 in the length direction may be set to ½ or more or ⅔ or more of the size of the power feed point 21 or may be set to 1/20 or more of the length of the imaginary straight line connecting the opposite ends of the power feed-side edge 17.

(Non-Power Feed-Side Slit in Patch)

The following description regarding a relationship among the non-power feed-side slit 25, the non-power feed-side edge 19, and the power feed point 21 may be regarded, unless otherwise specified, as description regarding a relationship among the first non-power feed-side slit 25A, the first non-power feed-side edge 19A, and the first power feed point 21A and description regarding a relationship among the second non-power feed-side slit 25B, the second non-power feed-side edge 19B, and the second power feed point 21B.

The non-power feed-side slit 25 extends in parallel to the non-power feed-side edge 19 at a position inside the patch 11 on a side nearer to the non-power feed-side edge 19. When the expression “on a side nearer to the non-power feed-side edge 19” is used, the meaning of that expression is as per described above in connection with the power feed point 21. Furthermore, the above description regarding the meaning of the expression “the power feed-side slit 23 extends in parallel to the power feed-side edge 17” may also be applied to the meaning of the expression “the non-power feed-side slit 25 extends in parallel to the non-power feed-side edge 19”. Accordingly, for example, the non-power feed-side slit 25 may be parallel (illustrated example) or may not be parallel to the non-power feed-side edge 19. However, in the description of this embodiment, the expression on the premise that they are parallel to each other is used in some cases.

The current flowing in the patch 11 tends to flow along the non-power feed-side slit 25. Accordingly, for example, when the polarized wave in association with the second power feed point 21B (the polarized wave vibrating in the y-direction) is the main polarization (the intended polarized wave), the direction of the current induced from the main polarization is easier to orient in the vibration direction of the main polarization with the presence of the first non-power feed-side slit 25A. Likewise, when the polarized wave in association with the first power feed point 21A is the main polarization, the direction of the current induced from the main polarization is easier to orient in the vibration direction of the main polarization with the presence of the second non-power feed-side slit 25B.

The non-power feed-side slit 25 may have any of various shapes. For example, the non-power feed-side slit 25 may extend in a constant width (illustrated example) or may include portions with different widths. In another example, the non-power feed-side slit 25 may extend linearly (illustrated example) or may include a bent or curved portion. In still another example, the non-power feed-side slit 25 may have a line-symmetric (illustrated example) or asymmetric shape with respect to a symmetry axis along a length direction of the non-power feed-side slit 25 and/or a symmetry axis along a width direction thereof.

A length of the non-power feed-side slit 25 may be set as appropriate. The length of the non-power feed-side slit 25 may be set to, for example, ⅔ or more and ⅘ or less of that of the non-power feed-side edge 19 or may be set to a value outside the above-mentioned range. The length of the non-power feed-side slit 25 may be longer than (illustrated example), equal or almost equal to, or shorter than that of the power feed-side slit 23.

In the illustrated example, the non-power feed-side slit 25 is longer than the power feed-side slit 23. A difference in length between both the slits may be set as appropriate. For example, the length of the non-power feed-side slit 25 may be set to 1.2 times or more or 1.5 times or more and 3 times or less or 2 times or less that of the power feed-side slit 23. The above-mentioned upper and lower limits may be combined as appropriate.

A width of the non-power feed-side slit 25 may be set as appropriate. As in the power feed-side slit 23, a minimum width of the non-power feed-side slit 25 may be set to be, for example, equal to or greater than the minimum value at which dielectric breakdown does not occur when the voltage at the level expected for the patch 11 is applied. Furthermore, the width (minimum width or maximum width) of the non-power feed-side slit 25 may be set to, for example, 1/30 or more and ⅕ or less of the length of the non-power feed-side slit 25 or may be set to a value outside the above-mentioned range.

A position of the non-power feed-side slit 25 may be set as appropriate in the length direction of the non-power feed-side edge 19. For example, the center of the overall length of the non-power feed-side slit 25 may be positioned at the center of the overall length of the non-power feed-side edge 19 or may be deviated from a position of the latter center (illustrated example). From a different point of view, in the illustrated example, the center of the overall length of the non-power feed-side edge 19 in the length direction of the non-power feed-side edge 19 is the position of the power feed point 21 that is positioned on the side nearer to the power feed-side edge 17 corresponding to the opposite side of the non-power feed-side edge 19.

In the illustrated example, the center of the overall length of the non-power feed-side slit 25 is deviated from the center of the overall length of the non-power feed-side edge 19 toward the power feed-side edge 17 intersecting the non-power feed-side edge 19 (for example, toward the second power feed-side edge 17B intersecting the first non-power feed-side edge 19A). An amount of the deviation may be set as appropriate. The amount of the deviation between both the centers may be set to, for example, 1/30 or more or 1/20 or more of the overall length of the non-power feed-side edge 19.

While, as described above, the non-power feed-side slit 25 is positioned on the side nearer to the non-power feed-side edge 19 in the direction orthogonal to the length direction of the non-power feed-side edge 19, a more specific position of the non-power feed-side slit 25 may be set as appropriate. For example, a distance between the non-power feed-side slit 25 and the non-power feed-side edge 19 may be smaller than, equal or almost equal to, or greater than the width of the non-power feed-side slit 25. Moreover, in the illustrated example, the non-power feed-side slit 25 is entirely positioned within one of five regions resulting from dividing a region between the non-power feed-side edge 19 and the power feed-side edge 17 corresponding to the opposite side of the non-power feed-side edge 19 into five equal parts, the one being nearest to the non-power feed-side edge 19.

A width (or a cross-sectional area) of a portion through which the current flows, the portion being positioned on a side adjacent to each of opposite ends of the non-power feed-side slit 25 and on a side adjacent to the non-power feed-side edge 19 may be taken into consideration in setting of the length, the width, and the position of the non-power feed-side slit 25. For example, a minimum width of the portion through which the current flows may be set to ⅓ or more or 1/1 or less of the size of the power feed point 21 or may be set to 1/30 or more of the length of the non-power feed-side edge 19.

(Power Feed Line)

The power feed line 13 extends linearly, for example, in the vibration direction of the polarized wave in association with itself (for example, the x-direction in the case of the first power feed line 13A). The power feed line 13 has one end connected to the patch 11 (the power feed point 21) and the other end connected to the power feed via 9. A width of the power feed line 13 is, for example, constant. In the illustrated example, however, an end portion of the power feed line 13 connected to the power feed via 9 has an increased size. Therefore, joining to the power feed via 9, for example, is ensured. A shape of the end portion may be set as desired and is circular in the illustrated example. The shape and size of the power feed line 13 may be set such that a ¼-wavelength conversion circuit is constituted, or that impedance at the power feed point 21 takes a predetermined value (for example, 50Ω).

(Ground Pattern)

The ground pattern 15 surrounds a combined pattern 27 made up of the patch 11 and the power feed line 13. As described above, the power feed line 13 may be omitted, for example, when the power feed via 9 is directly connected to the patch 11. In that case, the word “combined pattern 27” may be replaced with the patch 11. The above point is likewise applied to the following description.

The ground pattern 15 may be formed in an annular shape surrounding an entire periphery of the combined pattern 27 (illustrated example) or a shape including one or more interrupted parts. In the latter case, the ground pattern 15 may occupy a region of, for example, 180° or more, 270° or more, or 315° or more around the geometrical center of the patch 11 in total.

The specific shape and size of the ground pattern 15 may be set as appropriate. In an example, an outer edge of the ground pattern 15 may be in agreement with an outer edge of the second conductor layer 7 (namely, the ground plate) and/or an outer edge of the dielectric layer 5. Alternatively, a part or the whole of the outer edge of the ground pattern 15 may be positioned on an inner and/or outer side of the outer edge of the second conductor layer 7 or may be positioned on an inner side than the outer edge of the dielectric layer 5.

An inner edge of the ground pattern 15 may extend, for example, along an outer edge of the combined pattern 27. In the illustrated example, the inner edge of the ground pattern 15 has such a shape that the inner edge is positioned away by a substantially constant distance from an outer edge of an imaginary combined pattern resulting when the patch 11 does not include the protrusion 12. Stated another way, the inner edge of the ground pattern 15 has a similar shape (not limited to the meaning of the term “similar shape” used in mathematics) to the imaginary combined pattern. Alternatively, the inner edge of the ground pattern 15 may have such a shape (similar shape) that the inner edge is positioned away by a substantially constant distance from an outer edge of the actual combined pattern 27 including the protrusion 12.

A distance between the ground pattern 15 and each of the patch 11 and the power feed line 13 may be set to be, for example, equal to or greater than the minimum limit value at which dielectric breakdown does not occur when the voltage at the level expected for the patch 11 is applied. Furthermore, the above-mentioned distance may be set to be, for example, equal to or greater than the minimum width of the power feed-side slit 23 and/or the non-power feed-side slit 25.

A reference potential may be applied to the ground pattern 15 by any suitable method. For example, the reference potential may be applied by electrically connecting the ground pattern 15 to the second conductor layer 7 through a via (not illustrated) penetrating the dielectric layer 5. Alternatively, the reference potential may be applied in a different manner not using the second conductor layer 7.

(Second Conductor Layer)

FIG. 3 is a plan view of a second conductor layer 7.

The second conductor layer 7 spreads substantially without vacancies and is formed in the so-called solid pattern. However, the second conductor layer 7 has an opening 7a at the position of the power feed via 9 such that the second conductor layer 7 is not short-circuited to the power feed via 9. A shape, a diameter, and so on of the opening 7a may be set as appropriate. Note that the following description is made in some cases using expressions ignoring the presence of the opening 7a.

The second conductor layer 7 may include a portion other than a portion functioning as the ground plate. For example, a pad connected to the power feed via 9 may be disposed within the opening 7a at a position away from an edge of the opening 7a. However, the description of the embodiments is made, unless otherwise specified, on an assumption that the second conductor layer 7 is made of just the portion functioning as the ground plate.

In an example, the second conductor layer 7 has a size at least enough to overlap the whole of the patch 11 when seeing through the antenna from above. An outer edge of the second conductor layer 7 is entirely positioned, for example, on an outer side than an outer edge of the patch 11. The second conductor layer 7 may spread over the whole of the dielectric layer 5, or a part or the whole of the outer edge of the second conductor layer 7 may be positioned on an inner side than the outer edge of the dielectric layer 5.

The reference potential may be applied to the second conductor layer 7 by any suitable method. In an example, the second conductor layer 7 may be electrically connected to a signal ground and/or a frame ground through a conductor on a circuit substrate to which the antenna 1 is mounted and/or a conductor on a circuit substrate including the antenna 1.

(Power Feed Via)

As understood from the above description, the power feed via 9 penetrates the dielectric layer 5 in the thickness direction thereof and has an upper end joined to the end portion of the power feed line 13 and a lower end exposed from the opening 7a. Furthermore, the lower end of the power feed via 9 is connected to a transmitting circuit and/or a receiving circuit through a conductor on the circuit substrate to which the antenna 1 is mounted and/or a conductor on the circuit substrate including the antenna 1.

As described above, the antenna 1 according to this embodiment includes a conductive power feed patch (the patch 11). The patch 11 includes, in the plan view, the first power feed-side edge 17A and the first non-power feed-side edge 19A that are edges positioned on the opposite sides in a first direction (the x-direction), and the second power feed-side edge 17B and the second non-power feed-side edge 19B that are edges positioned on the opposite sides in a second direction (the y-direction) intersecting the x-direction. The patch 11 further includes, in the plan view, the first power feed point 21A positioned on the side nearer to the first power feed-side edge 17A and the second power feed point 21B positioned on the side nearer to the second power feed-side edge 17B.

Furthermore, in the plan view, at least the portion of the first power feed-side edge 17A may expand outward and may form the first protrusion 12A. The width of the first protrusion 12A in the y-direction may gradually decrease toward a top of the first protrusion 12A. The first power feed point 21A may be positioned nearer to the top of the first protrusion 12A than a middle of a hill slope of the first protrusion 12A in the x-direction.

In that case, as described above, the direction of the current flowing from the first power feed point 21A toward the inner side of the patch 11 tends to orient in the x-direction. Accordingly, for example, when the linearly polarized wave vibrating in the x-direction is the main polarization (the intended polarized wave), the influence of the linearly polarized wave vibrating in the y-direction (the not-intended polarized wave) upon the transmission and/or the reception of the main polarization is reduced. In other words, a difference between the main polarization and the not-intended linear polarization is increased. From a different point of view, isolation between the two linearly polarized waves is increased.

The whole of the first non-power feed-side edge 19A may be more closely analogous to a straight line than the whole of the first power feed-side edge 17A in the plan view.

In that case, for example, the above-described effect is obtained with the presence of the first protrusion 12A while, when the polarized wave vibrating in the direction along the first non-power feed-side edge 19A (the y-direction) is the main polarization, the direction of the current induced from that main polarization is easier to orient in the y-direction. Accordingly, the influence of the not-intended polarized wave vibrating in the x-direction upon the transmission and/or the reception of the main polarization is reduced. From a different point of view, the isolation between the two linearly polarized waves is increased.

In the plan view, edges (the slopes 17a) of a portion of the first protrusion 12A on opposite sides in the second direction (the y-direction), the portion having the width gradually decreasing toward the top of the first protrusion 12A, may include straight regions.

In that case, the patch 11 has a simpler shape and is easier to design as compared with, for example, a configuration in which the slope 17a has a curved shape (such a configuration also falls in the present disclosure). Furthermore, according to simulation calculation conducted by the inventor, the isolation was higher in the configuration in which the slope 17a is straight than in a configuration in which the first protrusion 12A has a semicircular shape.

In the plan view, the patch 11 may include the first power feed-side slit 23A extending in parallel to the first power feed-side edge 17A at the position on the side nearer to the first power feed-side edge 17A.

In that case, as described above, when the polarized wave in association with the second power feed point 21B (the polarized wave vibrating in the y-direction) is the main polarization, it is easier to orient the direction of the current near the first power feed-side slit 23A in the vibration direction of the main polarization. As a result, the isolation is increased. In this embodiment, the first power feed point 21A is positioned at the first power feed-side edge 17A, and the first power feed-side slit 23A is positioned on the inner side of the patch 11 than the first power feed point 21A. Accordingly, for example, when the polarized wave in association with the first power feed point 21A is the main polarization, there is a possibility that the first power feed-side slit 23A does not contribute to causing the current induced from the main polarization to orient in the vibration direction of the main polarization, or that the first power feed-side slit 23A rather impedes the above-described contribution. However, such a disadvantage is reduced, for example, by combination of the first power feed-side slit 23A with the first protrusion 12A.

The first power feed-side slit 23A may be positioned on the inner side of the patch 11 than the first power feed point 21A in the first direction (the x-direction). The edge of the first power feed-side slit 23A on the same side as the center of the patch 11 in the x-direction may be a straight line. The edge of the first power feed-side slit 23A on the same side as the first power feed point 21A in the x-direction may protrude toward the first power feed point 21A.

In that case, for example, the protruding edge of the first power feed-side slit 23A on the same side as the first power feed point 21A can contribute to causing the current flowing from the first power feed point 21A toward the inner side of the patch 11 to orient in the x-direction. Thus, while the effect of increasing the isolation when the polarized wave in association with the second power feed point 21B is the main polarization has been described above, by way of example, as the effect obtained with the presence of the first power feed-side slit 23A, the effect of increasing the isolation when the polarized wave in association with the first power feed point 21A is the main polarization is also obtained instead of or in addition to the above-described effect. On the other hand, the straight edge of the first power feed-side slit 23A on the same side as the center of the patch 11 can contribute to increasing the above-described effect of causing the current flowing from the second power feed point 21B toward the patch 11 to orient in the y-direction. As a result, the above-described effect of increasing the isolation, for example, when the polarized wave in association with the second power feed point 21B is the main polarization is increased.

The patch 11 may include the second non-power feed-side slit 25B extending in parallel to the second non-power feed-side edge 19B at the position on the side nearer to the second non-power feed-side edge 19B.

In that case, as described above, for example, when the polarized wave in association with the first power feed point 21A (the polarized wave vibrating in the x-direction) is the main polarization, it becomes easier to orient the direction of the current induced from the main polarization in the vibration direction of the main polarization. As a result, the isolation is increased.

The second non-power feed-side slit 25B may be longer than the first power feed-side slit 23A (and/or the second power feed-side slit 23B).

In that case, the second non-power feed-side slit 25B can be said as being relatively long. Accordingly, for example, the effect of increasing the isolation with the presence of the second non-power feed-side slit 25B is increased. From a different point of view, the first power feed-side slit 23A can be said as being relatively short. Accordingly, it is easier to allow the current to flow from the first power feed point 21A toward the inner side of the patch 11, for example, when the polarized wave in association with the first power feed point 21A is the main polarization.

The center of the entire length of the second non-power feed-side slit 25B may be positioned on the side nearer to the first power feed-side edge 17A than the center of the entire length of the second non-power feed-side edge 19B.

In the above case, the length of the second non-power feed-side slit 25B can be increased, for example, by extending the second non-power feed-side slit 25B toward the first power feed-side edge 17A. This enables the effect obtained with the presence of the second non-power feed-side slit 25B to be improved. When the second non-power feed-side slit 25B is extended toward the first power feed-side edge 17A, the second non-power feed-side slit 25B and the first power feed-side slit 23A come nearer to each other. As a result, a width of a current path extending, for example, from the first power feed point 21A toward the inner side of the patch 11 is narrowed. However, since the first power feed-side slit 23A is shorter than the second non-power feed-side slit 25B as described above, such a disadvantage is reduced.

The antenna 1 may include the ground pattern 15 positioned in the same plane as the patch 11 and surrounding the patch 11.

In that case, the ground pattern 15 contributes to cutting off, for example, the electric wave in the direction parallel to the xy-plane. Accordingly, for example, a directivity of the antenna 1 can be enhanced.

### Second Embodiment

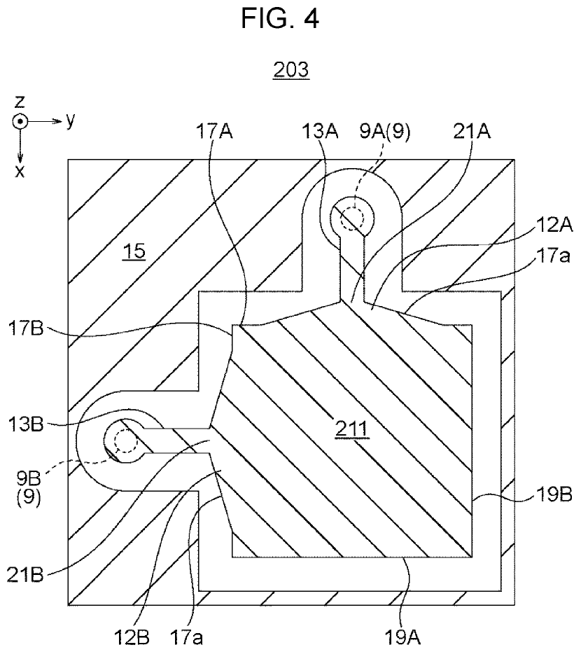

FIG. 4 is a plan view of a first conductor layer 203 in an antenna according to a second embodiment and corresponds to FIG. 2 illustrating the first embodiment.

The second embodiment is different from the first embodiment just in a point that a patch 211 does not include the power feed-side slit 23 and the non-power feed-side slit 25. In other words, the patch 211 in the second embodiment has a configuration in which a square patch includes the protrusion 12.

Specific sizes at which the characteristics of the antenna are optimized are different depending on whether the power feed-side slit 23 and the non-power feed-side slit 25 are present. Accordingly, even when the first embodiment and the second embodiment are targeted for the same wavelength, the specific sizes and so on in both the embodiments may be different from each other. This point is likewise applied to the other embodiments described below.

In this embodiment, as in the first embodiment, at least a portion of the first power feed-side edge 17A expands outward and forms the first protrusion 12A in a plan view. In the first protrusion 12A, its width in the second direction (the y-direction) gradually decreases toward the top of the first protrusion 12A, and the first power feed point 21A is positioned nearer to the top of the first protrusion 12A than the middle of the hill slope of the first protrusion 12A in the first direction (the x-direction x). As in the first embodiment, therefore, when the linearly polarized wave vibrating in the x-direction is the main polarization, the direction of the current is easier to orient in the x-direction than in a configuration in which the first protrusion 12A is not disposed. As a result, the isolation is increased.

(Variation)

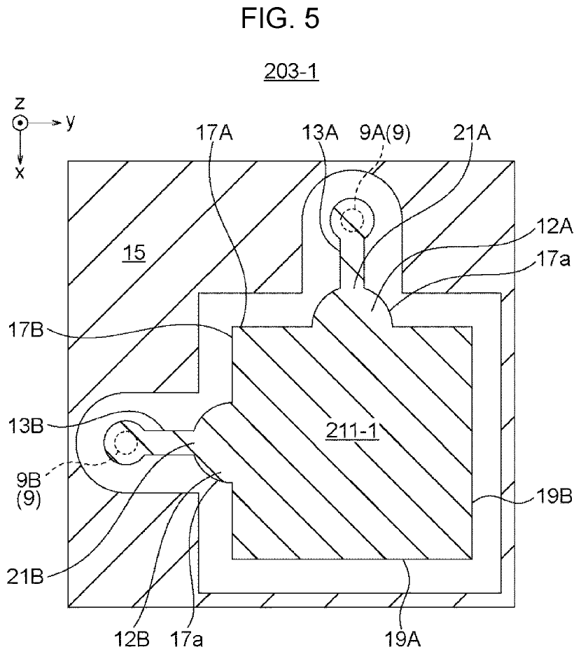

FIG. 5 is a plan view of a first conductor layer 203-1 in an antenna according to a variation of the second embodiment and corresponds to FIG. 2 illustrating the first embodiment.

As described above, the protrusion 12 may have any suitable shape. In a patch 211-1 according to this variation, the protrusion 12 has a semicircular shape. From a different point of view, the slope 17a of the power feed-side edge 17 has a curved shape expanding outward.

Even with the protrusion 12 having the above-mentioned shape, as in the second embodiment, when the linearly polarized wave vibrating in the x-direction is the main polarization, the direction of the current is easier to orient in the x-direction than in the configuration in which the first protrusion 12A is not disposed. Hence the isolation is increased. Furthermore, since the slope 17a of the first protrusion 12A has the curved shape expanding outward, the slope 17a, for example, is more closely parallel to the x-direction at a position nearer to a square portion of the patch 211-1. As a result, it becomes easier to orient the current in the x-direction at the position nearer to the square portion.

While the semicircular shape is mentioned here as the shape of the protrusion 12 in the variation of the second embodiment, the semicircular shape of the protrusion 12 may be further applied to the first embodiment or the other embodiments described later.

### Third Embodiment

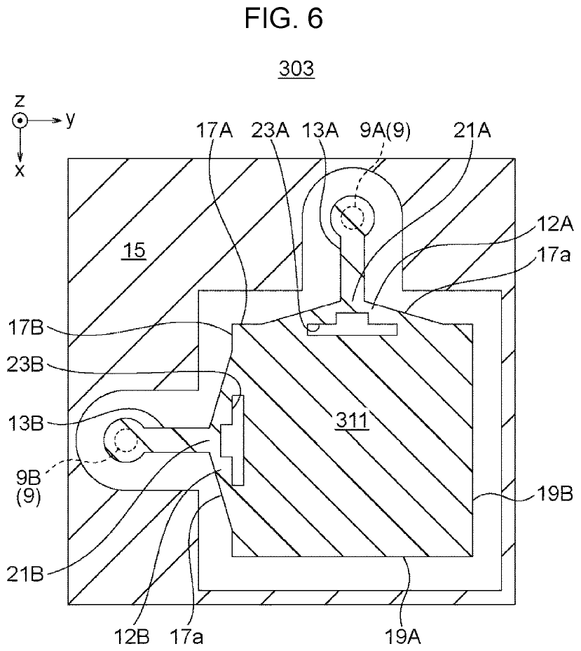

FIG. 6 is a plan view of a first conductor layer 303 in an antenna according to a third embodiment and corresponds to FIG. 2 illustrating the first embodiment.

The third embodiment is different from the first embodiment just in a point that a patch 311 does not include the non-power feed-side slit 25. In other words, the patch 311 in the third embodiment has a configuration in which a square patch includes the protrusion 12 and the power feed-side slit 23.

In this embodiment, since at least a portion of the first power feed-side edge 17A expands outward and forms the first protrusion 12A in a plan view, the same and/or similar effects as and/or to those in the first embodiment can also be obtained. For example, when the linearly polarized wave vibrating in the x-direction is the main polarization, the direction of the current is easier to orient in the x-direction than in the configuration in which the first protrusion 12A is not disposed, and hence the isolation is increased.

### Fourth Embodiment

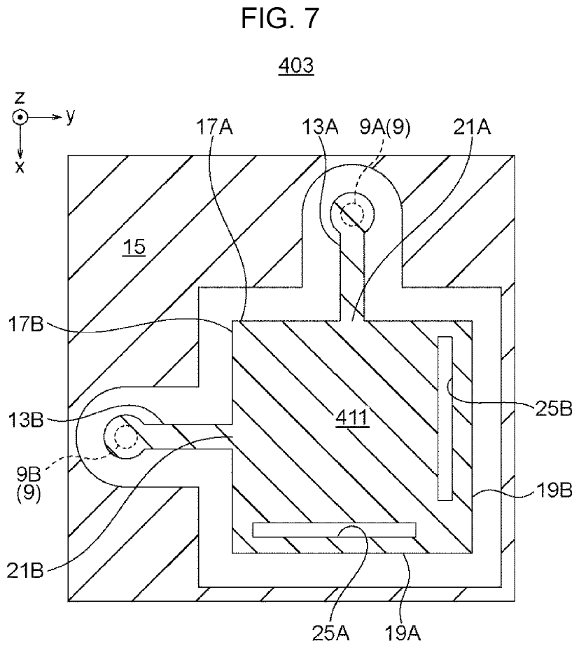

FIG. 7 is a plan view of a first conductor layer 403 in an antenna according to a fourth embodiment and corresponds to FIG. 2 illustrating the first embodiment.

The fourth embodiment is different from the first embodiment just in a point that a patch 411 does not include the protrusion 12 and the power feed-side slit 23. In other words, the patch 411 in the fourth embodiment has a configuration including the non-power feed-side slit 25.

In this embodiment, as in the first embodiment, the patch 411 includes the second non-power feed-side slit 25B extending in parallel to the second non-power feed-side edge 19B at the position on the side nearer to the second non-power feed-side edge 19B. Accordingly, the same and/or similar effects as and/or to those in the first embodiment can also be obtained. For example, when the linearly polarized wave vibrating in the x-direction is the main polarization, the direction of the current is easier to orient in the x-direction than in a configuration in which the second non-power feed-side slit 25B is not formed, and hence the isolation is increased.

### Fifth Embodiment

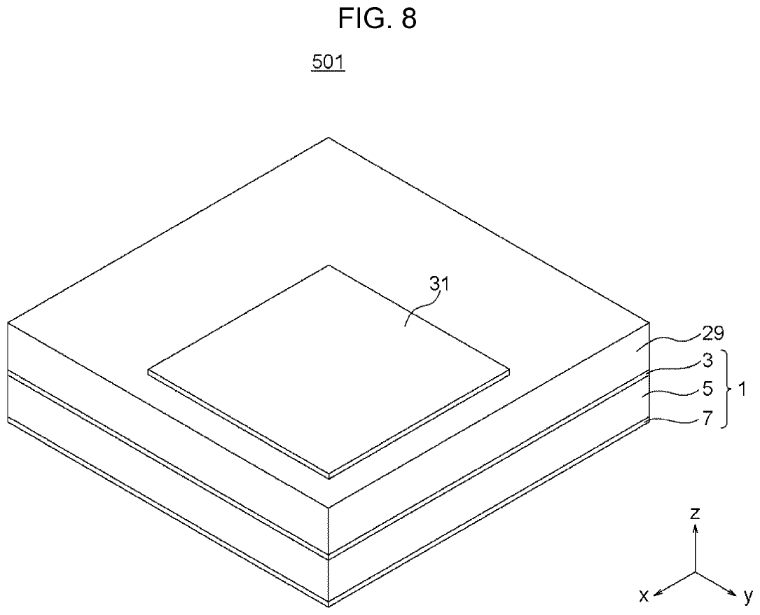

FIG. 8 is a perspective view of an antenna 501 according to a fifth embodiment and corresponds to FIG. 1 illustrating the first embodiment.

The antenna 501 has a configuration in which a dielectric layer 29 and a patch 31 are laminated in addition to the configuration of the antenna 1 according to the first embodiment. The patch 31 is a non-power feed patch (in an electrically floating state) and is positioned opposite to the patch 11 with the dielectric layer 29 interposed therebetween. The provision of the patch 31 enables a predetermined one of various characteristics demanded for the antenna to be improved. For example, a broader band can be realized.

The above description of the dielectric layer 5 may be applied to the dielectric layer 29 as well. A material of the dielectric layer 29 may be the same as or different from that of the dielectric layer 5. In FIG. 8, the dielectric layer 29 is illustrated as having a thickness equal or almost equal to that of the dielectric layer 5. In practice, the thickness of the dielectric layer 29 (and the dielectric layer 5) may be set as appropriate in consideration of the characteristics of the antenna. In other words, the thickness of the dielectric layer 29 may be different from that of the dielectric layer 5.

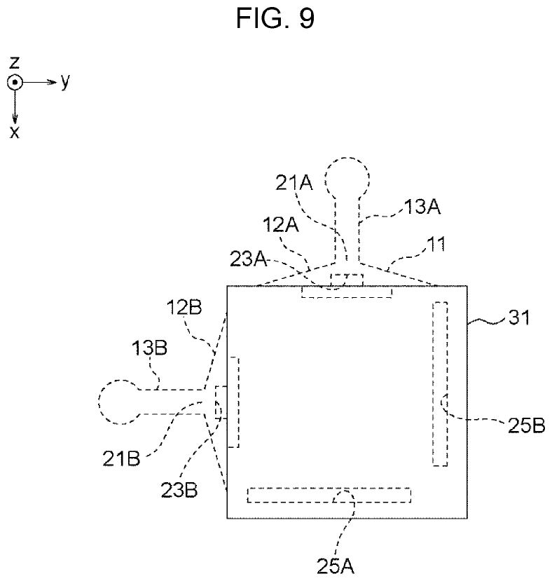

FIG. 9 is a plan view of the antenna 501 when viewed in a seeing-through way. In FIG. 9, the patch 31 is drawn by a solid line, and the patch 11 is drawn by a dotted line.

In an example, the patch 31 spreads without vacancies and is formed in the so-called solid pattern. However, the patch 31 may include a slit. In this case, a shape, a position, and so on of the slit in the patch 31 may be the same as and/or similar to those of the slit in the patch 11 or may be different from them. In the following description, expressions on the premise that the patch 31 does not include the slit are used in some cases.

In the plan view, the shape of the patch 31 may be set as appropriate. In the illustrated example, the patch 31 has a square plan shape. Stated another way, the plan shape of the patch 31 corresponds to the shape that is the base for the shape of the patch 11. Stated still another way, the patch 31 includes four edges extending along the first power feed-side edge 17A, the first non-power feed-side edge 19A, the second power feed-side edge 17B, and the second non-power feed-side edge 19B of the patch 11 in one-to-one relation. Those four edges are each, for example, straight and is more closely analogous to a straight line than the power feed-side edge 17 forming the protrusion 12. Unlike the illustrated example, the plan shape of the patch 31 may be the same as that of the patch 11 including the protrusion 12, or may be different from both of the shape that is the base for the shape of the patch 11 and the plan shape of the patch 11 including the protrusion 12.

In the plan view, a size and a position of the patch 31 may be set as appropriate. In the illustrated example, the size of the patch 31 is set to be equal or almost equal to the size of the shape (here, square) that is the base for the shape of the patch 11. Furthermore, in the plan view when viewed in a seeing-through way, outer edges of the patch 31 are arranged to be in agreement with those of the shape that is the base for the shape of the patch 11. Moreover, in the illustrated example, the geometrical center of the patch 31 is in agreement with that of the shape that is the base for the shape of the patch 11. Unlike the illustrated example, a part or the whole of the outer edges of the patch 31 may be positioned on an inner or outer side of the outer edges of the shape that is the base for the shape of the patch 11. Moreover, the geometrical center of the patch 31 and the geometrical center of the shape that is the base for the shape of the patch 11 may be deviated from each other.

In the plan view when viewed in a seeing-through way, for example, the whole (illustrated example) of the protrusion 12 of the patch 11 or its part on a side nearer to the top of the protrusion 12 is positioned outside the patch 31. The power feed point 21 is positioned, for example, outside the patch 31. A part (illustrated example) or the whole of the power feed-side slit 23 overlaps the patch 31. In the illustrated example, a portion of the power feed-side slit 23 in the width direction thereof, the portion being positioned inside the patch 11, overlaps the patch 31. For example, a part or the whole (illustrated example) of the non-power feed-side slit 25 overlaps the patch 31. Unlike the illustrated example, the whole of the protrusion 12 may overlap the patch 31, the power feed point 21 may overlap the patch 31, the whole of the power feed-side slit 23 may be positioned outside the patch 31, or the whole of the non-power feed-side slit 25 may be positioned outside the patch 31.

As described above, the antenna 501 may further include the conductive non-power feed patch (the patch 31) positioned opposite to the power-feed patch (the patch 11). In the plan view when viewed in a seeing-through way, the patch 31 may include the four edges extending along the first power feed-side edge 17A, the first non-power feed-side edge 19A, the second power feed-side edge 17B, and the second non-power feed-side edge 19B in one-to-one relation. The whole of the edge of the patch 31, that edge extending along the first power feed-side edge 17A, may be more closely analogous to a straight line than the whole of the first power feed-side edge 17A.

In the above case, in the patch 11, for example, when the linearly polarized wave vibrating in the x-direction is the main polarization, it becomes easier to orient a flow of the current in the x-direction with the presence of the first protrusion 12A in a zone near the first power feed point 21A where a singular point tends to generate with respect to the flow of the current. On the other hand, in the patch 31, because of not including the first power feed point 21A, the necessity of including a portion in the same and/or similar shape as and/or to the first protrusion 12A is low. Thus, since the edge of the patch 31 extending along the first power feed-side edge 17A is more closely analogous to a straight line (namely, since the protrusion is not formed in that edge), it is easier to orient the current in the y-direction, for example, when the linearly polarized wave vibrating in the y-direction is the main polarization.

The patch 31 may overlap at least a portion of the first power feed-side slit 23A in the plan view when viewed in a seeing-through way. In addition or alternatively, the patch 31 may overlap at least a portion of the second non-power feed-side slit 25B in the plan view when viewed in a seeing-through way.

In the above case, in the patch 11, for example, the direction of the current induced from the main polarization can be oriented in the vibration direction of the main polarization with the presence of the power feed-side slit 23 and/or the non-power feed-side slit 25. On the other hand, in the patch 31, a current corresponding to the current caused to orient in the vibration direction of the main polarization by the patch 11 can be generated over a large area. As a result, an improvement in the characteristics of the antenna is expected.

While the fifth embodiment is described above as using the first conductor layer 3 in the first embodiment, the first conductor layer in any of the other embodiments may also be used. Stated another way, the patch 31 may be disposed in any of the second to fourth embodiments.

### Application Example

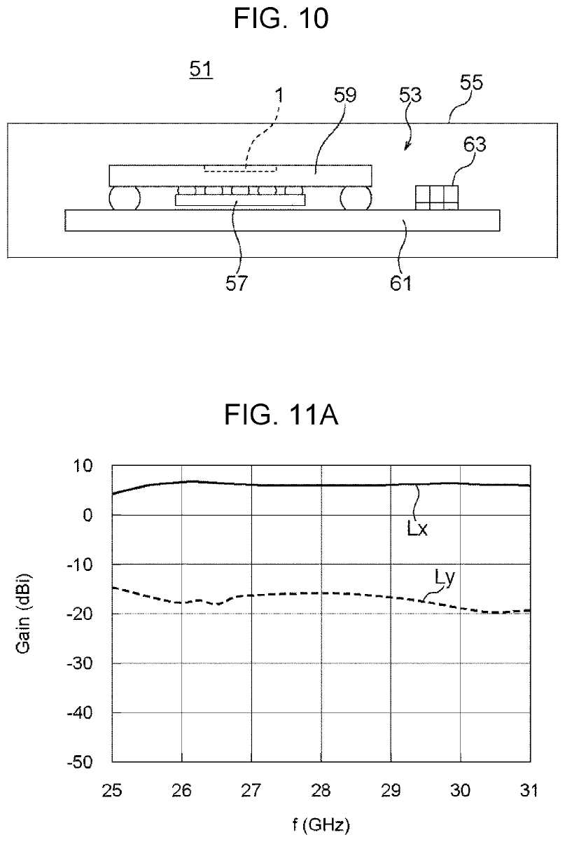

FIG. 10 is a schematic view illustrating a configuration of an electronic device 51 as an application example of the antenna according to the embodiment. While, in the following description, the reference sign “1” indicating the antenna 1 according to the first embodiment is used for convenience, the antenna according to any of the other embodiments may also be used in the electronic device 51.

The electronic device 51 may be implemented in various configurations. The electronic device 51 may be, for example, a communication device. The communication device may include, for example, a mobile terminal, a base station, a relay station, a base unit of a wireless LAN (Local Area Network), a receiver for a satellite positioning system, antenna devices removably attached to various electronic devices, a radio, a television, and an in-vehicle device for an electronic toll collection (ETC) system. The mobile terminal may be, for example, a mobile phone (including a smartphone), a tablet PC (Personal Computer), or a note PC. Furthermore, the electronic device 51 other than the communication device may include a radar device and a microwave oven. The following description is made in some cases on the premise that the electronic device 51 is the communication device.

The electronic device 51 includes, for example, an antenna module 53 and a housing 55 accommodating the antenna module 53.

The antenna module 53 includes, for example, the antenna 1, a transmitting circuit for transmitting an electric wave through the antenna 1, and/or a receiving circuit for receiving an electric wave through the antenna 1. The transmitting circuit and/or the receiving circuit may be constituted by, for example, one ore more ICs (Integrated Circuits) 57. The IC 57 is, for example, a RF (Radio Frequency)—IC and is electrically connected to the lower ends of the two power feed vias 9 as described above.

The transmitting circuit may perform, for example, frequency-up conversion and modulation of a base band signal including any desired information and may input a radio frequency signal to the antenna 1. At that time, for example, the transmitting circuit may selectively feed powers to the two power feed vias 9 (from a different point of view, to the two power feed points 21) and may selectively transmit two linearly polarized waves. In more detail, for example, the transmitting circuit may alternately output the two linearly polarized waves at a predetermined period. As an alternative, just one of the two linearly polarized waves may be transmitted in accordance with setting made by a user at all times (until the setting is changed). Unlike the above case, the transmitting circuit may supply currents in phases shifted 90° from each other to the two power feed vias 9 such that a circularly polarized wave is transmitted.

The receiving circuit may perform, for example, frequency-down conversion and demodulation of a radio frequency signal from the antenna 1 and may obtain a base band signal including any desired information. At that time, for example, the receiving circuit may selectively utilize currents from the two power feed vias 9 (from a different point of view, from the two power feed points 21). In more detail, for example, the receiving circuit may perform the above-mentioned processing (the demodulation, etc.) on just one of two currents in accordance with setting made by a user at all times (until the setting is changed). As an alternative, the receiving circuit may perform the above-mentioned processing on just a larger one of the two currents from the two power feed vias 9. Unlike the above case, the receiving circuit may perform, on the currents from the two power feed vias 9, processing that is the same as and/or similar to the processing performed by a receiving circuit for receiving a circularly polarized wave.

A specific connection form between the IC 57 (the transmitting circuit and/or the receiving circuit) and the antenna 1 is selected as desired. In the illustrated example, the antenna 1 is constituted as a portion of an antenna substrate 59 on a side including one main surface thereof. The IC 57 is mounted to the other main surface of the antenna substrate 59. Moreover, the power feed via 9 is electrically connected to the IC 57 through a conductor (a conductor layer and/or a via) inside the antenna substrate 59.

In the illustrated example, the antenna module 53 includes, in addition to the antenna substrate 59 and the IC 57, a mounting substrate 61 to which the antenna substrate 59 is mounted and an electronic component 63 mounted to the mounting substrate 61. The IC 57 (the transmitting circuit and/or the receiving circuit) may be a component mounted to the mounting substrate 61.

As understood from the above-described examples of the various forms (such as the mobile terminal) of the electronic device 51, a material, a size, and a shape of the electronic device 51 are set as desired. A relationship in relative size between the antenna 1 and the electronic device 51 is also set as desired.

### EXAMPLE

A specific material, size, and so on of the antenna according to the embodiment were set, and characteristics of the antenna were examined by simulation calculation. As a result, it was found that the isolation was improved depending on the shape of the patch according to the embodiment. Details are as follows.

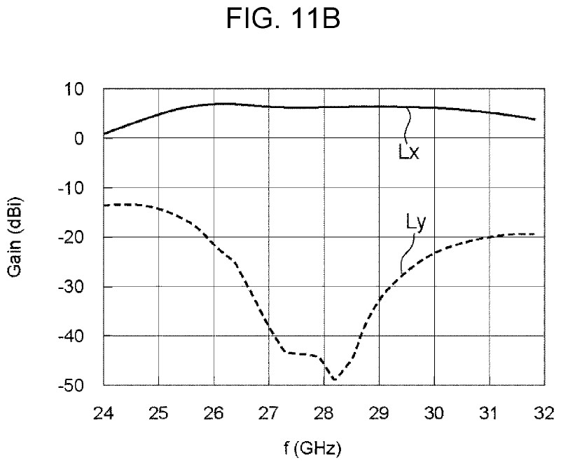

FIG. 11A is a graph representing characteristics of an antenna according to COMPARATIVE EXAMPLE. FIG. 11B is a graph representing characteristics of an antenna according to EXAMPLE. In these graphs, a horizontal axis indicates a frequency f (GHz), and a vertical axis indicates a gain (dBi).

Here, the antenna according to EXAMPLE includes the patch 11 in the first embodiment. The antenna according to COMPARATIVE EXAMPLE includes a patch formed in a square shape and a solid pattern. In other words, COMPARATIVE EXAMPLE is different from EXAMPLE in that the protrusion 12, the power feed-side slit 23, and the non-power feed-side slit 25 are omitted from the latter. Both the antennas are supposed to be used in a frequency band with a center frequency being at 28 GHz.

The simulation was premised on such a situation that a current was supplied from the first power feed via 9A to the first power feed line 13A and that the linearly polarized wave vibrating in the x-direction was transmitted. In FIGS. 11A and 11B, a line Lx indicates a gain of the linearly polarized wave vibrating in the x-direction and being the main polarization. On the other hand, a line Ly indicates a gain of the linearly polarized wave vibrating in the y-direction and being the not-intended polarization.

As understood from comparison between FIG. 11A and FIG. 11B, in EXAMPLE, a difference between the gain of the main polarization and the gain of the not-intended polarization (the difference being also called “isolation”) near 28 GHz is larger than in COMPARATIVE EXAMPLE. More specifically, the isolation in COMPARATIVE EXAMPLE is about 22 dB at 28 GHz while the isolation in EXAMPLE is about 52 dB.

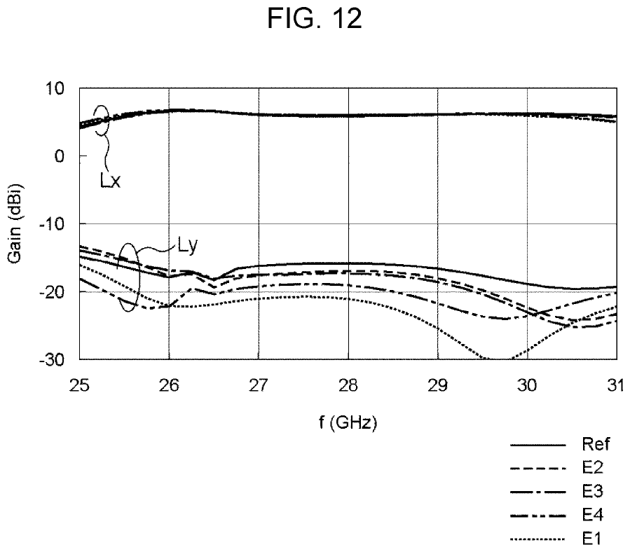

FIG. 12 is a graph representing the isolation in each of COMPARATIVE EXAMPLE and EXAMPLES corresponding to the first to fourth embodiments.

The meanings of a horizontal axis, a vertical axis, a line Lx, and a line Ly in FIG. 12 are the same as those in FIGS. 11A and 11B. In the legend attached to FIG. 12, “Ref” corresponds to COMPARATIVE EXAMPLE. “E1”, “E2”, “E3”, and “E4” correspond to FIRST EXAMPLE, SECOND EXAMPLE, THIRD EXAMPLE, and FOURTH EXAMPLE, respectively.

COMPARATIVE EXAMPLE is the same as and/or similar to that represented in FIG. 11A. FIRST EXAMPLE, SECOND EXAMPLE, THIRD EXAMPLE, and FOURTH EXAMPLE are respectively EXAMPLE including the patch 11 according to the first embodiment, EXAMPLE including the patch 211 according to the second embodiment, EXAMPLE including the patch 311 according to the third embodiment, and EXAMPLE including the patch 411 according to the fourth embodiment. COMPARATIVE EXAMPLE and EXAMPLES have the same configuration except for the presence or the absence of the protrusion 12, the power feed-side slit 23, and the non-power feed-side slit 25. While EXAMPLE represented in FIG. 11B is EXAMPLE including the patch 11 like FIRST EXAMPLE represented in FIG. 12, sizes and so on are adjusted in the former for optimization in consideration of the presence of the protrusion 12, the power feed-side slit 23, and the non-power feed-side slit 25, and hence EXAMPLE represented in FIG. 11B is different from FIRST EXAMPLE.

As seen from FIG. 12, in each of FIRST to FOURTH EXAMPLES, the isolation is increased near 28 GHz in comparison with COMPARATIVE EXAMPLE. More specifically, in the illustrated example, the order descending from a highest level of the isolation is given by FIRST EXAMPLE, FOURTH EXAMPLE, THIRD EXAMPLE, and SECOND EXAMPLE. Judging from the fact that FIRST EXAMPLE has the highest isolation and THIRD EXAMPLE has the higher isolation than SECOND EXAMPLE, it was confirmed that the isolation can be increased according to a combination of the protrusion 12, the power feed-side slit 23, and the non-power feed-side slit 25.

In EXAMPLES represented in FIG. 12, the protrusion 12 had a triangular shape as in the embodiments. Although not illustrated specifically, it was also confirmed that, comparing with COMPARATIVE EXAMPLE, the isolation was increased in EXAMPLE (not including the power feed-side slit 23 and the non-power feed-side slit 25) in which the shape of the protrusion 12 was changed into a semicircular shape in the second embodiment. Moreover, under the conditions of the sizes used in this simulation, the isolation in SECOND EXAMPLE was higher than that in the above-mentioned EXAMPLE including the semicircular protrusion 12.

In the above-described embodiments and so on, the patches 11, 211, 211-1, 311, and 411 are each an example of the power-feed patch. The patch 31 is an example of the non-power feed patch. The x-direction is an example of the first direction. The y-direction is an example of the second direction.

The technique according to the present disclosure may be implemented in other various embodiments as well without being limited to the above-described embodiments.

For example, the antenna does not need to include the dielectric layer 5. For example, a space (from a different point of view, air) may exist under the power feed patch (such as the patch 11). The above point is likewise applied to the dielectric layer 29 in the case in which the non-power feed patch (the patch 31) is disposed. When the dielectric layer is not disposed between two conductor layers opposite to each other, those two conductor layers may be fixed to each other by using insulating posts.

For example, the antenna does not need to include the second conductor layer 7 (the ground plate). For example, the earth or a different member other than the antenna may be utilized instead of the second conductor layer 7. The different member may be, for example, a housing to which the antenna is fixed, or a ground layer in a circuit substrate to which the antenna is mounted. In such a case, the entirety of a section including the housing or the circuit substrate may be regarded as the antenna.

For example, the antenna (from a different point of view, the first conductive layer) does not need to include the ground pattern 15. Furthermore, as suggested in the description of the embodiments, power may be fed to the power feed patch (such as the patch 11) in a configuration in which the power feed line 13 is not disposed. From a different point of view, the first conductor layer may be constituted by the power feed patch alone.

As understood from the above description, the antenna may be constituted by the power feed patch (such as the patch 11) alone. Even in the configuration in which the dielectric layer 5, the second conductor layer 7, the ground pattern 15, the power feed line 13, and/or the power feed via 9 are disposed, the power feed patch alone may be regarded as the antenna.

Contrary to the above-mentioned cases, the antenna may further include constituent elements that are not referred to in the embodiments. For example, a conductor layer with an opening of an appropriate shape may be arranged above (+z-side) the power feed patch (for example, the patch 11). Such a conductor layer functions as, for example, a filter. When the conductor layer with the opening is combined with the non-power feed patch (the patch 31), it may be positioned between the power feed patch and the non-power feed patch or above the non-power feed patch.

In the above description of the embodiments, the power feed-side slit is described on the premise that the power feed-side edge adjacent to the power feed-side slit includes the protrusion. However, the power feed-side slit may be formed in the patch not including the protrusion. Moreover, in the above description of the embodiments, the power feed point is described as being positioned on the side nearer to the power feed-side edge than the power feed-side slit, but the power feed point may be positioned on the inner side of the patch than the power feed-side slit.

The antenna may be utilized as an antenna constituting an array antenna. For example, in the antenna substrate 59 illustrated in FIG. 10, multiple antennas may be arrayed along an upper surface of the antenna substrate 59.

### REFERENCE SIGNS

1 . . . antenna, 11 . . . patch (power feed patch), 17A . . . first power feed-side edge, 17B . . . second power feed-side edge, 19A . . . second non-power feed-side edge, 19B . . . second non-power feed-side edge, 21A . . . first power feed point, 21B . . . second power feed point, 12A . . . first protrusion (protrusion), and 25B . . . second non-power feed-side slit (non-power feed-side slit).

1. An antenna comprising a conductive power feed patch,
wherein the power feed patch comprises, in a plan view:
a first power feed-side edge and a first non-power feed-side edge positioned on opposite sides in a first direction in one-to-one relation;
a second power feed-side edge and a second non-power feed-side edge positioned on opposite sides in a second direction intersecting the first direction in one-to-one relation;
a first power feed point positioned on a side nearer to the first power feed-side edge; and
a second power feed point positioned on a side nearer to the second power feed-side edge,
wherein, in the plan view, at least a portion of the first power feed-side edge expands outward and forms a protrusion,
wherein a width of the protrusion in the second direction gradually decreases toward a top of the protrusion, and
wherein the first power feed point is positioned nearer to the top of the protrusion than a middle of a hill slope of the protrusion in the first direction.

2. The antenna according to claim 1,
wherein a whole of the first non-power feed-side edge is more closely analogous to a straight line than a whole of the first power feed-side edge in the plan view.

3. The antenna according to claim 1,
wherein, in the plan view, edges of a portion of the protrusion on opposite sides in the second direction, the portion having the width gradually decreasing toward the top of the protrusion, include straight regions.

4. The antenna according to claim 1,
wherein, in the plan view, edges of a portion of the protrusion on opposite sides in the second direction, the portion having the width gradually decreasing toward the top of the protrusion, include curved regions expanding outward.

5. The antenna according to claim 1,
wherein, in the plan view, the power feed patch comprises a power feed-side slit extending in parallel to the first power feed-side edge at a position on the side nearer to the first power feed-side edge.

6. The antenna according to claim 5,
wherein the power feed-side slit is positioned on an inner side of the power feed patch than the first power feed point in the first direction,
an edge of the power feed-side slit on same side as a center of the power feed patch in the first direction has a straight shape, and
an edge of the power feed-side slit on same side as the first power feed point in the first direction has a shape protruding toward the first power feed point.

7. The antenna according to claim 1,
wherein the power feed patch comprises a non-power feed-side slit extending in parallel to the second non-power feed-side edge at a position on the side nearer to the second non-power feed-side edge.

8. The antenna according to claim 7,
wherein, in the plan view, the power feed patch comprises a power feed-side slit extending in parallel to the first power feed-side edge at a position on the side nearer to the first power feed-side edge, and wherein the non-power feed-side slit is longer than the power feed-side slit.

9. The antenna according to claim 8,
wherein a center of an entire length of the non-power feed-side slit is positioned on a side nearer to the first power feed-side edge than a center of an entire length of the second non-power feed-side edge.

10. An antenna comprising a conductive power feed patch,
wherein the power feed patch comprises, in a plan view:
a first power feed-side edge and a first non-power feed-side edge positioned on opposite sides in a first direction in one-to-one relation;
a second power feed-side edge and a second non-power feed-side edge positioned on opposite sides in a second direction intersecting the first direction in one-to-one relation;
a first power feed point positioned on a side nearer to the first power feed-side edge; and
a second power feed point positioned on a side nearer to the second power feed-side edge,
wherein the power feed patch further comprises a non-power feed-side slit extending in parallel to the second non-power feed-side edge at a position on a side nearer to the second non-power feed-side edge.

11. The antenna according to claim 1, further comprising a conductive non-power feed patch positioned opposite to the power feed patch,
wherein the non-power feed patch includes, in a plan view when viewed in a seeing-through way, four edges extending along the first power feed-side edge, the first non-power feed-side edge, the second power feed-side edge, and the second non-power feed-side edge in one-to-one relation, and
a whole of an edge of the non-power feed patch along the first power feed-side edge is more closely analogous to a straight line than a whole of the first power feed-side edge.

12. The antenna according to claim 5, further comprising a conductive non-power feed patch positioned opposite to the power feed patch,
wherein the non-power feed patch overlaps at least a portion of the power feed-side slit in a plan view when viewed in a seeing-through way.

13. The antenna according to claim 7, further comprising a conductive non-power feed patch positioned opposite to the power feed patch,
wherein the non-power feed patch overlaps at least a portion of the non-power feed-side slit in a plan view when viewed in a seeing-through way.

14. The antenna according to claim 1, further comprising a ground pattern positioned on same plane as the power feed patch and surrounding the power feed patch.

15. An antenna module comprising:
the antenna according to claim 1, and
an IC electrically connected to the first power feed point and the second power feed point.

16. An electronic device comprising:
the antenna module according to claim 15, and
a housing accommodating the antenna module.
